(19) United States
(12) Patent Application Publication
(10) Pub. No.: US 2005/0281332 A1
(43) Pub. Date: Dec. 22, 2005

(54) Transform coefficient decoding

(76) Inventors: Wai-Ming Lai, Plano, TX (US); Minhua Zhou, Plano, TX (US)

Correspondence Address: TEXAS INSTRUMENTS INCORPORATED, P O BOX 655474, M/S 3999, DALLAS, TX, 75265, US

(21) Appl. No.: 11/158,686

(22) Filed: Jun. 22, 2005

Related U.S. Application Data
(60) Provisional application No. 60/582,183, filed on Jun. 22, 2004.

(51) Int. Cl. H04B 1/66; H04N 11/02; H04N 11/04; H04N 7/12

(52) U.S. Cl. 375/240.03; 375/240.25; 375/240.24; 375/240.18

(57) ABSTRACT

Decoding of H.264 transform coefficients with four arithmetic units in parallel provides efficiency.

### CROSS-REFERENCE TO RELATED APPLICATIONS

This application claims priority from provisional application No. 60/582,183, filed Jun. 22, 2004. The following coassigned pending patent applications disclose related subject matter:

### BACKGROUND

The present invention relates to digital video signal processing, and more particularly to devices and methods for video compression.

Various applications for digital video communication and storage exist, and corresponding international standards have been and are continuing to be developed. Low bit rate communications, such as, video telephony and conferencing, led to the H.261 standard with bit rates as multiples of 64 kbps. Demand for even lower bit rates resulted in the H.263 standard.

H.264/AVC is a recent video coding standard that makes use of several advanced video coding tools to provide better compression performance than existing video coding standards such as MPEG-2, MPEG-4, and H.263. At the core of all of these standards is the hybrid video coding technique of block motion compensation plus transform coding. Block motion compensation is used to remove temporal redundancy between successive images (frames), whereas transform coding is used to remove spatial redundancy within each frame. FIGS. 2a-2b illustrate H.264/AVC functions which include a deblocking filter within the motion compensation loop to limit artifacts created at block edges.

Traditional block motion compensation schemes basically assume that between successive frames an object in a scene undergoes a displacement in the x- and y-directions and these displacements define the components of a motion vector. Thus an object in one frame can be predicted from the object in a prior frame by using the object's motion vector. Block motion compensation simply partitions a frame into blocks and treats each block as an object and then finds its motion vector which locates the most-similar block in the prior frame (motion estimation). This simple assumption works out in a satisfactory fashion in most cases in practice, and thus block motion compensation has become the most widely used technique for temporal redundancy removal in video coding standards

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264. The residual (prediction error) block can then be encoded (i.e., transformed, quantized, VLC). The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264 uses an integer approximation to a 4×4 DCT.

For predictive coding using block motion compensation, inverse-quantization and inverse transform are needed for the feedback loop. The rate-control unit in FIG. 2a is responsible for generating the quantization step (qp) in an allowed range and according to the target bit-rate and buffer-fullness to control the transform-coefficients quantization unit. Indeed, a larger quantization step implies more vanishing and/or smaller quantized coefficients which means fewer and/or shorter codewords and consequent smaller bit rates and files.

There are two kinds of coded macroblocks. An Intra-coded macroblock is coded independently of previous reference frames but may use prediction from within its frame. For an Inter-coded macroblock, a motion-compensation prediction block from a previous reference frame is first generated, then the prediction error block (i.e. the residual difference block between current block and the prediction block) is encoded. Residual (prediction error) blocks are first transformed to a frequency domain (e.g., 8×8 DCT for MPEG or 4×4 integer approximation to DCT for H.264) and then encoded (i.e., quantization, data reorganization, further transformation, etc.).

The first (0,0) coefficient is called the DC coefficient, and the rest of 63 DCT-coefficients or 15 integer transform coefficients in the block are AC coefficients. The DC coefficients may be quantized with a fixed value of the quantization step, whereas the AC coefficients have quantization steps adjusted according to the bit rate control which compares bit used so far in the encoding of a picture to the allocated number of bits to be used. Further, a quantization matrix (e.g., as in MPEG-4) allows for varying quantization steps among the DCT coefficients.

The process of decoding the transform coefficients in a H.264 video coder involves various steps of data reorganization, inverse quantization, and inverse transformation. FIG. 1a shows a block diagram of the whole procedure. A more detailed description can be found in the H.264 specification. The inputs to this process are retrieved from the bitstream using variable length decoding. These inputs include sixteen 4×4 blocks of luminance (luma) AC data, eight 4×4 blocks of chrominance (chroma) AC data, one 4×4 block of luma DC data and two 2×2 blocks of chroma DC data. (Luma is also denoted Y, and the two chromas are also denoted U and V.) At the output, decoded transform coefficients are presented in the form of sixteen 4×4 blocks of luma data and eight 4×4 blocks of chroma data. The coded block patterns for the 16 blocks of luma AC blocks are also generated as a by-product. This process involves a lot of repetitive computation loops and is heavy on the processor loading. Implementing this process efficiently is the key to meeting aggressive frame decoding rate targets. In most embedded applications such as digital still cameras and mobile TVs, the decoding is performed in a programmable multimedia processor.

### SUMMARY OF THE INVENTION

The present invention provides decoding of transform coefficients for H.264 video coding with parallel arithmetic operations to efficiently reassemble transformed macroblocks.

Preferred embodiment implementations use four parallel arithmetic units which adapts to the 2×2 and 4×4 transforms of the DC coefficients.

### BRIEF DESCRIPTION OF THE DRAWINGS

FIGS. 1a-1c are a flow diagram and preferred embodiment implementations on four arithmetic units.

FIGS. 2a-2c show video coding functional blocks and transmission.

FIG. 3 illustrates memory locations.

FIGS. 4a-4b shows inverse zig-zag scan.

FIG. 5 is block swapping.

FIG. 6 converts from inverse zig-zag to matrix raster scan.

FIG. 7 shows memory locations.

FIG. 8 shows a system for preferred embodiment methods.

FIG. 9 illustrates macroblock decomposition.

### DESCRIPTION OF THE PREFERRED EMBODIMENTS

1. Overview

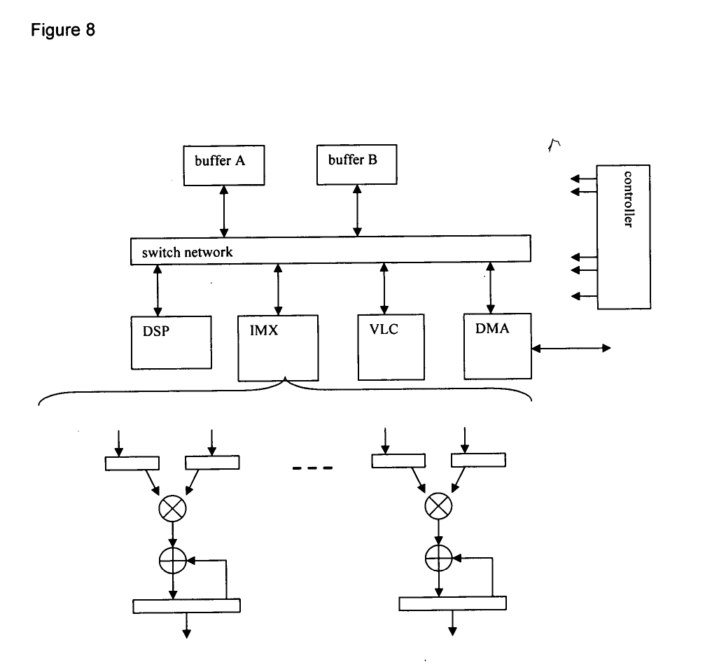

Preferred embodiment methods and processors include parallel arithmetic units for executing computation-intensive processes. FIG. 8 illustrates a multiple processor system with the IMX engine as containing parallel arithmetic units; the engine would typically contain two, four, or eight parallel arithmetic units. All units simultaneously perform the same operation, such as multiplication, addition, subtraction, absolute difference, min, max, bitwise or, and, xor, table lookup, in addition to accumulation. Input data to the units is read at Ihe same time from a specific part of the memory that is shared with the main processor. The process of memory read, computation, accumulation and memory write can be done in a single cycle if there is no memory conflict. To fully utilize the computational power of the parallel processing characteristic, data must be structured to fit in the engine's architecture. For example, the number of input and output values must be a multiple of N in an N-unit engine. Data must be arranged in a certain order to fully utilize all the units. Input and output buffers used in the same operation should be in different sections of the memory to minimize memory conflict. And in some engines, data buffers need to be aligned on N-word boundaries.

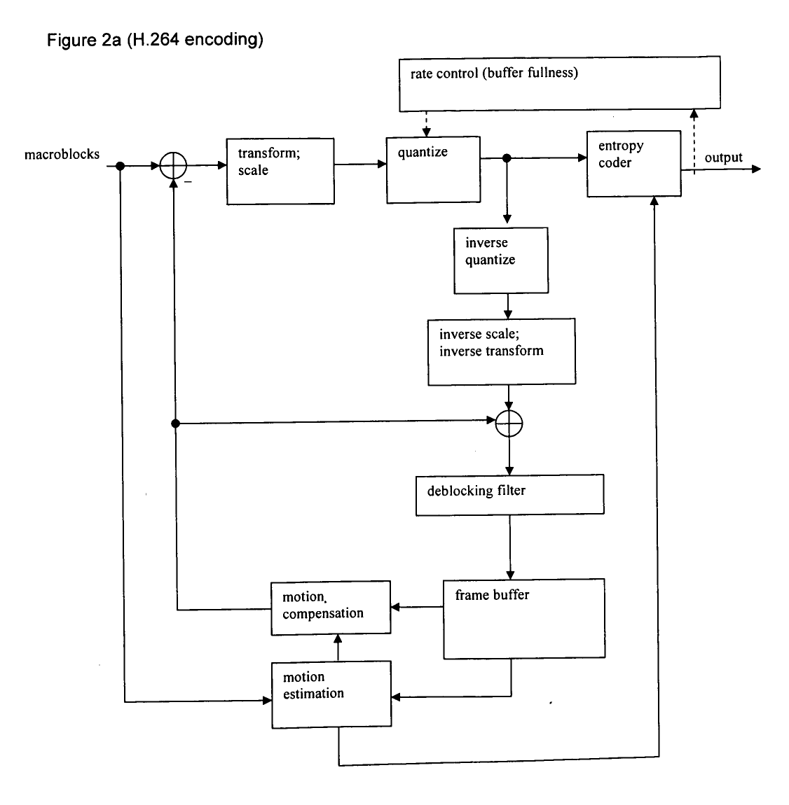

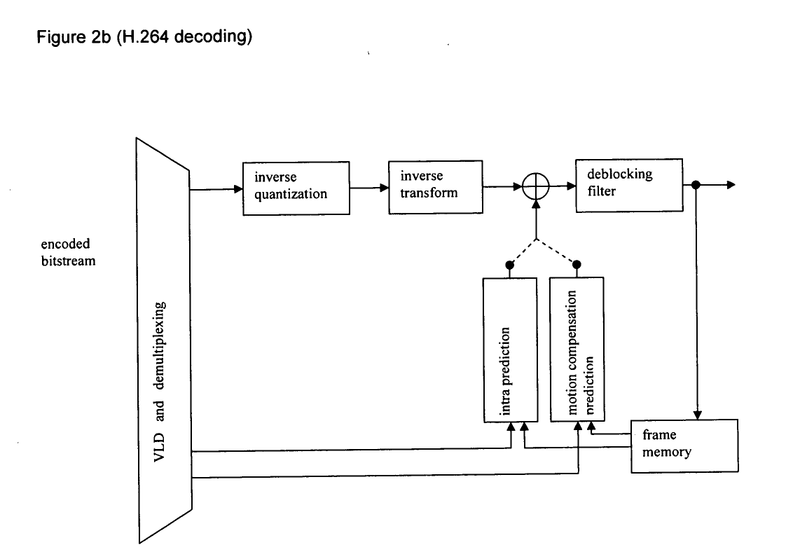

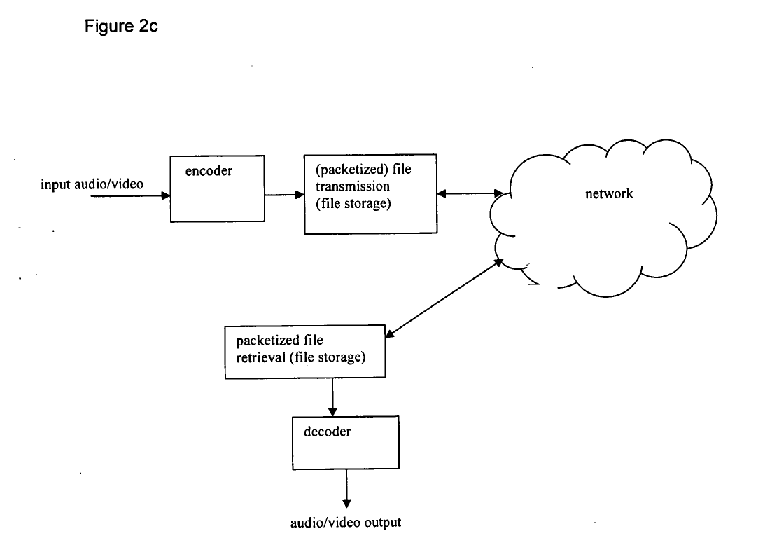

Preferred embodiment systems (e.g., cellphones, PDAS, digital cameras, notebook computers, etc.) perform preferred embodiment methods with any of several types of hardware which include parallel arithmetic units, such as digital signal processors (DSPs), general purpose programmable processors, application specific circuits, or systems on a chip (SoC) with multicore processor arrays or with various specialized programmable accelerators which include parallel arithmetic units (e.g., FIG. 8). A stored program in an onboard or external (flash EEP)ROM or FRAM could implement the signal processing methods. Analog-to-digital and digital-to-analog converters can provide coupling to the analog world; modulators and demodulators (plus antennas for air interfaces such as for video on cellphones) can provide coupling for transmission waveforms; and packetizers can provide formats for transmission over networks such as the Internet as illustrated in FIG. 2c.

### 2. First Preferred Embodiment

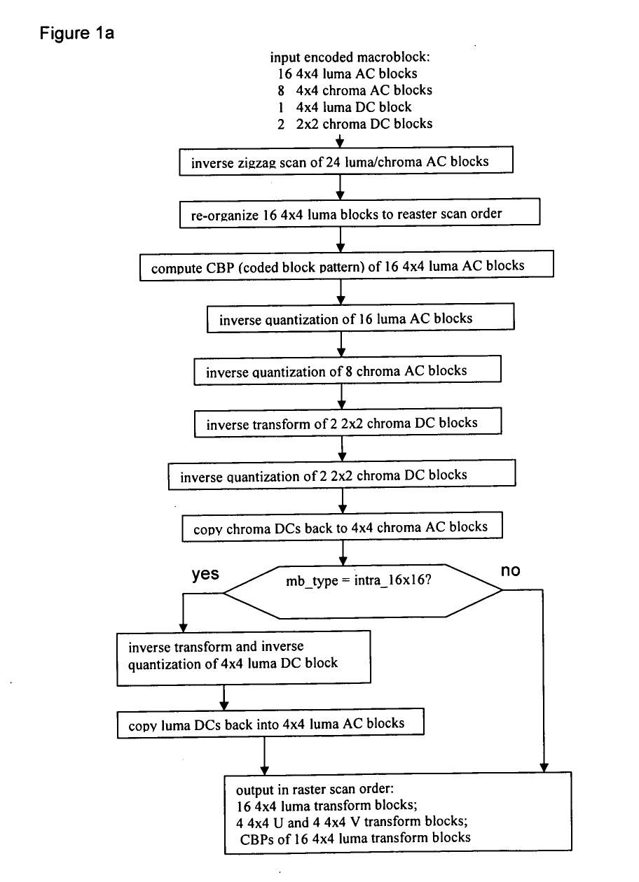

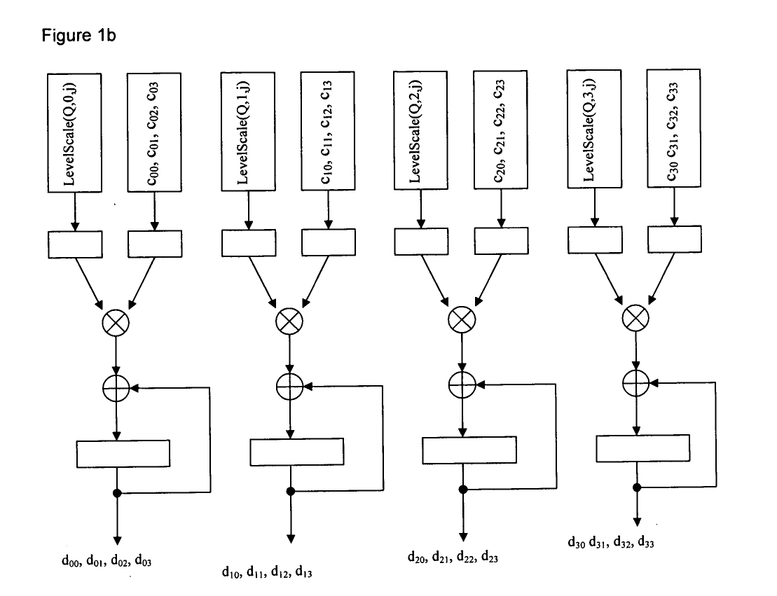

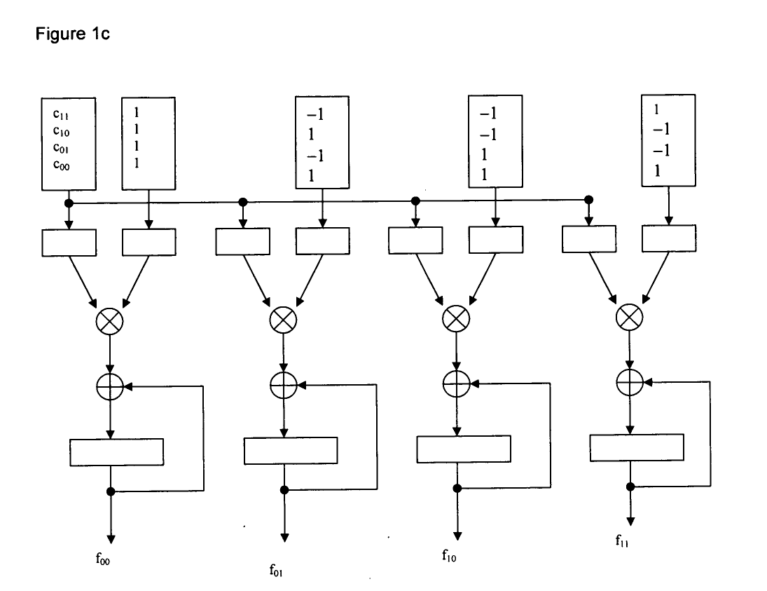

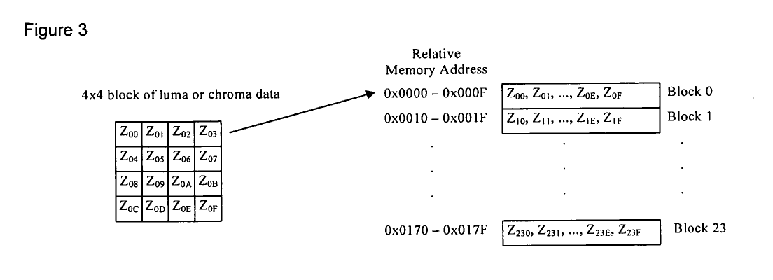

First, consider received transform coefficient data for a macroblock after entropy decoding. The AC and DC data are in two separate buffers; the AC buffer (Tcoeff_AC) contains sixteen 4×4 blocks of AC luma data and eight 4×4 blocks of chroma AC data, while the DC buffer (Tcoeff_DC) contains one 4×4 block of luma data and two 2×2 blocks of chroma data. All the 2-dimensional blocks are stored linearly in raster scan order. FIG. 3 shows how Tcoeff_AC buffer is stored in memory with Zjk denoting a generic pixel value (byte/word of luminance or chrominance). Blocks 0 to 15 (hexadecimal 0 to F) are the luma AC data with each block being sixteen bytes/words, blocks 16 to 19 (hexadecimal 10 to 13) are chroma-U AC data, and blocks 21 to 23 (hexadecimal 14 to 17) are chroma-V AC data. Similarly, in the Tcoeff_DC buffer, the 4×4 luma DC block takes up the first 16 locations (each location contains a byte/word), followed by the 2×2 chroma-U block taking the next four locations, then the 2×2 chroma-V block taking four locations. FIG. 1a illustrates the following steps to decode the transformed and quantized luminance and chrominance data of a macroblock.

Step 1. Inverse Zig-Zag Scan on Each 4×4 Block of Tcoeff_AC

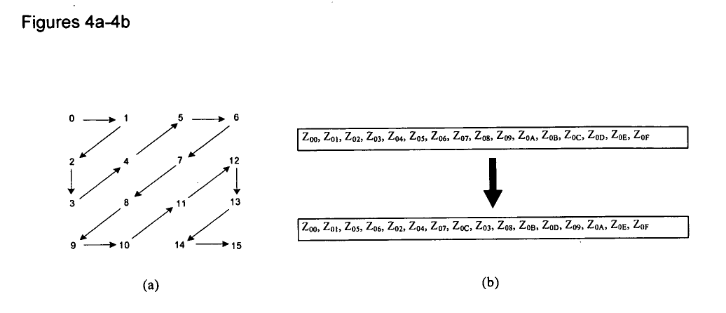

A table lookup operation is used for performing the inverse zig-zag scan. A buffer containing the scan sequence is used as the input indices and Tcoeff_AC is used as the lookup table; FIGS. 4a-4b illustrate the inverse zig-zag for block 0. The re-ordered output is stored in a temporary buffer. Alternatively, write back to original block memory once a block is re-ordered.

Note that the original zig-zag scanning of the 4×4 transform coefficients was to put the coefficients in frequency order for efficient quantization and run-length encoding.

Step 2. Inverse Block Scan of 4×4 Luma Blocks in Macroblock

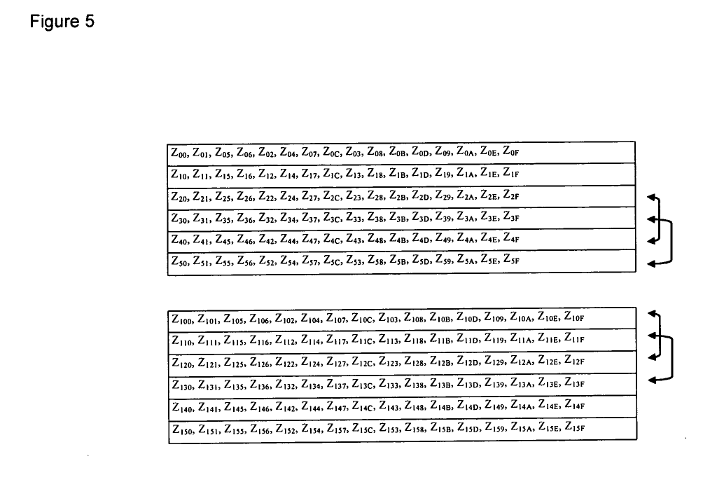

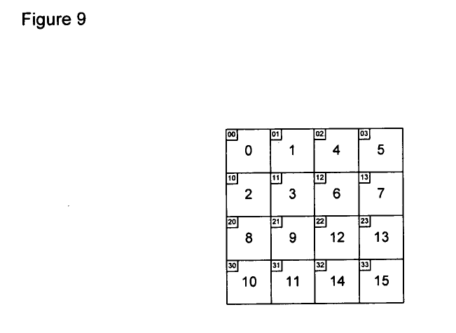

As shown in FIG. 5, block 2 is swapped with block 4, and block 3 is swapped with block 5. Similarly block 10 is swapped with block 12, and block 11 is swapped with block 13. This swapping reassembles the 8×8 blocks of the macroblock; FIG. 9 shows the original ordering of the 4×4 blocks within a 16×16 macroblock.

First blocks 2 and 3 are copied to a temporary buffer, blocks 4 and 5 are then copied over to block 2 and 3, and finally the temporary buffer that holds original data from blocks 2 and 3 are copied to blocks 4 and 5. The same process is repeated for blocks 10 and 11. In the parallel arithmetic unit engine as in FIG. 8 with four arithmetic units, the copy operation can be accomplished as an arithmetic operation by a dummy add (adding 0) or a dummy multiply (multiply by 1). Since each copy can move 4 data in a 4-arithmetic-unit engine, each block (16 bytes/words) can be done in 4 copy operations. In this case, a total of 48 copies is needed to swap all the blocks.

Step 3. Compute Coded Block Pattern for the Sixteen 4×4 Luma AC Blocks

The value of the coded block pattern (CBP) for a luma block n is defined as 0 if all coefficients in block n are equal to 0 and is defined as 1 if any coefficient in the block is non-zero. First, the absolute values of the coefficients are computed by doing a dummy absolute difference (absolute difference with zero) and the output is stored in a temporary buffer in the transposed order. The sum of each block is then computed and clipped to 1. The re-ordering of the temporary data makes it possible to do the summation of 4 blocks simultaneously.

Step 4. Inverse Quantization of Luma and Chroma AC Data

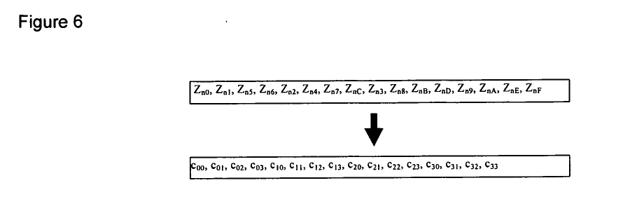

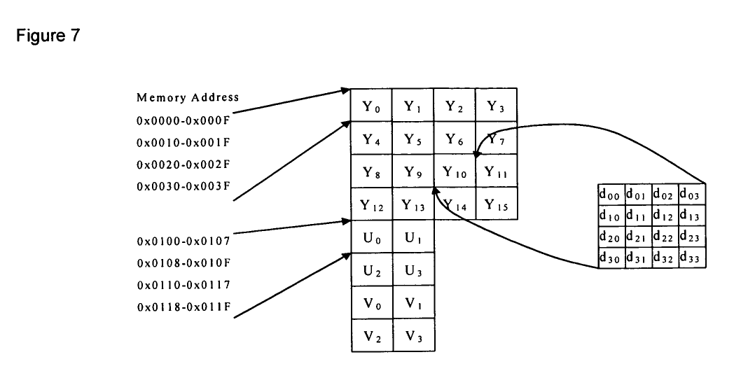

The H.264 standard prescribes the following for inverse quantization of AC data with QP the quantization parameter for AC luma data and QP_c the quantization parameter for AC chroma data:
dᵢⱼ=(cᵢⱼ*LevelScale(qP %6,i,j))>>(qP/6) with i,j=0, 1,2,3; qP=QP or QP_c
For the nth 4×4 block, the elements cᵢⱼ corresponds to the received Zₙₖ elements as shown in FIG. 6; the order within the block is the inverse zig-zag. In the implementation, qP %6 and qP/6 are computed first, and the inverse quantization table LevelScale(qP %6) is then scaled by 2^{(qP/6)}. This scaled table and the cᵢⱼ's are fed as input to the parallel arithmetic engine. Four sets of data are multiplied at a time and each block takes four multiplication cycles; see FIG. 1b. One scaled table is used for all 16 luma blocks, and another scaled table is used for all 8 chroma blocks. The output blocks of data are re-organized into the macroblock format as shown in FIG. 7 where Yₙ denotes a block of 4×4 transform domain luma data and Uₙ and Vₙ denote blocks of 4×4 transform domain chroma data.
Step 5. Inverse 2×2 Transform of Chroma 2×2 Block DC Data

The inverse transform for DC chroma in H.264 is:

$$f = [ \begin{matrix}1 & 1 \\ 1 & - 1\end{matrix} ] [ \begin{matrix}{c}_{00} & {c}_{01} \\ {c}_{10} & {c}_{…}\end{matrix} ] [ \begin{matrix}1 & 1 \\ 1 & - 1\end{matrix} ]$$

This matrix equation in terms of matrix elements expands to:
f₀₀=c₀₀+c₀₁+c₁₀+c₁₁
f₀₁=c₀₀−c₀₁+c₁₀−c₁₁
f₁₀=c₀₀+c₀₁−c₁₀−c₁₁
f₁₁=c₀₀−c₀₁−c₁₀+c₁₁
   To implement this, a 4×4 coefficient array equal to {1, 1, 1, 1, 1, −1, 1, −1, 1, 1, −1, −1, 1 −1, −1, 1} is used. Each arithmetic unit computes one of the fⱼₖ by four multiply-accumulate cycles. At each cycle the arithmetic units all take the same cᵢⱼ and multiply by one of 4 elements from the coefficient array, first coo with {1, 1, 1, 1}, next c₀₁ with {1, −1, 1, −1}, then c₁₀ with {1, 1, −1, −1}, and lastly c₁₁ with {1, −1, −1, 1}. The accumulated results from each unit yield the inverse 2×2 transformed data fᵢⱼ; see FIG. 1c.
   Step 6. Inverse Quantization of Chroma 2×2 Block DC Data

In H.264 the inverse quantization for DC chroma data from step 5 is:
dcCᵢⱼ=((fᵢⱼ*LevelScale(QP_{—}c %6,0,0))<<(QP_{—}c/6)) . . . 1 with i,j=0,1
This equation is very similar to the one used in step 4, and hence the implementation is very much the same. The values of (QP_c %6) and (QP_c/6) are computed first, and LevelScale(QP_c %6, 0, 0) is scaled by 2^{(QP}^{_{—}}^{c/6)}. The inputs to the arithmetic units are the inverse transformed data from step 5 and the scaled level, and a multiplication operation is performed. The output is shifted one bit to the right before writing to the memory.
Step 7. Copy Chroma DC Data into Chroma AC Blocks

Each of the chroma DC data is copied to the (0,0) first position of the corresponding 4×4 chroma block. Since the output of this operation is in separate memory locations, the data have to be copied one by one.

Step 8. If Macroblock Type is Equal to Intra 16×16, Inverse Zig-Zag Scan, Inverse Transform and Inverse Quantization of Luma DC Data

The inverse zig-zag scan is the same as step 1, in which the 4×4 luma DC block is re-ordered.

$$f = [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ] [ \begin{matrix}{c}_{00} & {c}_{01} & {c}_{02} & {c}_{03} \\ {c}_{10} & {c}_{11} & {c}_{12} & {c}_{13} \\ {c}_{20} & {c}_{21} & {c}_{22} & {c}_{23} \\ {c}_{30} & {c}_{31} & {c}_{32} & {c}_{33}\end{matrix} ] [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ]$$

The inverse transform is done in two steps, each step similar to step 5. Indeed, let g be the 4×4 product of matrix multiplying the right two matrices

$$g = [ \begin{matrix}{c}_{00} & {c}_{01} & {c}_{02} & {c}_{03} \\ {c}_{10} & {c}_{11} & {c}_{12} & {c}_{13} \\ {c}_{20} & {c}_{21} & {c}_{22} & {c}_{23} \\ {c}_{30} & {c}_{31} & {c}_{32} & {c}_{33}\end{matrix} ] [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ]$$

Then multiplying out gives row 0 of g as:
g₀₀=c₀₀+c₀₁+c₀₂+C₀₃
g₀₁=c₀₀+c₀₁−c₀₂−c₀₃
g₀₂=c₀₀−c₀₁−c₀₂+c₀₃
g₀₃=c₀₀−c₀₁+c₀₂−c₀₃
   This has the same structure as step 5 (if identify g₀₀, g₀₁, g₀₂, g₀₃ with f₀₀, f₁₀, f₁₁, f₀₁, respectively) and is similarly done on the four arithmetic units in parallel. Likewise for row 1 of g the same structure:
g₁₀=c₁₀+c₁₁+c₁₂+c₁₃
g₁₁=c₁₀+c₁₁−c₁₂−c₁₃
g₁₂=c₁₀−c₁₁−c₁₂+c₁₃
g₁₃=c₁₀−c₁₁+c₁₂−c₁₃
Again, use the four arithmetic units in parallel as for row 0. Rows 2 and 3 of g are analogous. Then the computation of f is:

$$f = [ \begin{matrix}1 & 1 & 1 & 1 \\ 1 & 1 & - 1 & - 1 \\ 1 & - 1 & - 1 & 1 \\ 1 & - 1 & 1 & - 1\end{matrix} ] g$$

Again, matrix multiplying yields column 0 of f:
f₀₀=g₀₀+g₁₀+g₂₀+g₃₀
f₁₀=g₀₀+g₁₀−g₂₀−g₉₃₀
f₂₀=g₀₀−g₁₀−g₂₀+g₃₀
f₃₀=g₀₀−g₁₀+g₂₀−g₃₀
   Thus, the same structure as the g row computations, and the four arithmetic units operate in parallel to compute the four components of column 0 of f. This has the same structure as the g₀ₖ computation because the transform matrices are symmetric. Similarly, compute the four components of the columns fₖ₁, fₖ₂, and fₖ₃ in terms of the columns gₖ₁, gₖ₂, and gₖ₃, respectively, in parallel with four arithmetic units.

The inverse quantization of the DC luma data is then:
dcYᵢⱼ=((fᵢⱼ*LevelScale(QP %6,0,0))<<(QP/6)+2)>>2 with i,j=0,1,2,3
This inverse quantization is very similar to step 6 and is implemented in the same way.
Step 9. Copy Luma DC Data into (0,0) Positions of Luma AC Blocks

Each of the luma DC data is copied to the (0,0) first position of the corresponding 4×4 luma block in the same way as in step 7.

The resulting data is then (inverse) transformed from the frequency domain to the spatial domain where the blocks are prediction residual data. The transformation is a 4×4 integer transform which uses the following matrix and its transpose:

$$[ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ]$$

Together with various scaling factors, this approximates the 4×4 DCT.

3. Modifications

The preferred embodiments may be modified in various ways while retaining one or more of the features of parallel decoding of transform coefficients of H.264.

For example, the number of parallel arithmetic units could be varied, the matrix multiplications for inverse transforms could be taken in reverse order, the block sizes could be varied with corresponding changes in numbers of blocks, and so forth.

1. A method of decoding video compression transform coefficients, comprising
(a) receiving transform data for a macroblock, said data including sixteen 4×4 luma AC blocks, eight 4×4 luma DC blocks, one 4×4 chroma AC block, and two 2×2 chroma DC blocks;
(b) inverse transforming said chroma DC block with a separate arithmetic unit for each coefficient;
(c) combining said chroma DC coefficients with said 4×4 chroma AC blocks;
(d) combining coefficients of said luma DC block with said 4×4 luma AC blocks.

2. The method of claim 1, further comprising:
(a) ordering said sixteen luma AC blocks into raster-scan order within said macroblock.

3. The method of claim 1, further comprising:
(a) inverse zig-zag scanning within each of said luma AC blocks and each of said chroma AC blocks.

4. The method of claim 1, further comprising:
(a) inverse quantizing within each of said luma AC blocks and each of said chroma AC blocks.

5. The method of claim 1, further comprising:
(a) when said macroblock is type intra_{—}16×16, prior to (d) of claim 1,
(i) inverse zig-zag scanning within said luma DC block;
(ii) inverse transforming said luma DC block with a separate arithmetic unit for each row or column of coefficients; and
(iii) inverse quantizing said coefficients.
